(19) United States
(12) Patent Application Publication
(10) Pub. No.: US 2018/0097264 A1
(43) Pub. Date: Apr. 5, 2018

(54) BATTERY SYSTEM AND METHOD FOR MONITORING A TEMPERATURE OF A BATTERY SYSTEM

(71) Applicant: Robert Bosch GmbH, Stuttgart (DE)

(72) Inventors: Alfons Doerr, Stuttgart (DE); Peter Bauckhage, Ilsfeld (DE)

(21) Appl. No.: 15/567,342

(22) PCT Filed: Mar. 15, 2016
(86) PCT No.: PCT/EP2016/055497

§ 371 Date: Oct. 17, 2017

(30) Foreign Application Priority Data
Apr. 21, 2015 (DE) 10 2015 207 165.0

(51) Int. Cl. H01M 10/48; G02B 6/24; H01M 10/02; G01K 11/12

(52) U.S. Cl. CPC H01M 10/486; G02B 6/24; H01M 10/04; G01K 11/12; H01M 10/482; H01M 10/02

(57) ABSTRACT

The invention relates to a battery system, comprising at least one battery component (10), which has at least one measurement point (12_{a-g}), and comprising an optical waveguide (14), which is connected to the measurement point (12_{a-g}) in a thermally conductive manner, wherein a light source (16_{a-d}) is provided for radiating light of a defined frequency into the optical waveguide (14) and an optical detector (18) is provided for detecting light exiting the optical waveguide (14), characterized in that a thermochromatic material (30) is provided, which is connected to the measurement point (12_{a-g}) in a thermally conductive manner and is positioned in a beam path of the optical waveguide (14). In summary, a reliable and robust possibility for the temperature monitoring of one or more battery components (10) is thus enabled in a simple and economical manner.

### BACKGROUND OF THE INVENTION

The present invention relates to a battery system and to a method for monitoring a temperature of the battery system, in which a maximum temperature and/or minimum temperature of at least one battery component can be monitored in particularly cost-effective and robust manner.

It is hardly possible nowadays to imagine being without the most diverse batteries such as, for instance, lithium-based energy-storage devices or lithium-ion batteries. Besides fully electrically-driven vehicles or hybrid vehicles, fields of application also encompass electrical tools, consumer electronics, computers, mobile phones and further applications.

Sensor technology is increasingly required in electric vehicles or hybrid vehicles for the purpose of establishing an overheating of the battery or of the accumulator—generally, of an electrochemical energy-storage device—since a large amount of energy is drawn from this energy-storage device, and a failure of this energy-storage device would have fatal consequences for the operation of the electric vehicle or hybrid vehicle.

In the limiting case, when a cell has exceeded a certain temperature limit, the cell is in danger of entering an unstable state in which thermal runaway may destroy the entire battery in a chain reaction. Therefore an accurate monitoring of the cell temperatures is indispensable. The conventional thermocouples and the electronics for evaluation have to be galvanically insulated.

A conventional temperature measurement in a battery is undertaken, for the most part, via electrical/electronic thermocouples such as, for example, type K, NTC. Alternative measuring methods include the use of optical temperature measurements by ascertaining Stokes and anti-Stokes signals, or the use of infrared radiation.

From document DE 10 2013 203 971 A1, for example, a method for registering a temperature is known, in which input light is coupled into an optical waveguide, output light, which is emitted from the optical waveguide in response to the input light coupled in, is registered, and the output light is analyzed in order to determine a temperature at at least one measuring-point. This method is based on the fact that, by virtue of the alteration of the temperature at the measuring-points, the temperature of the optical waveguide and hence the optical property of the optical waveguide at this position of the measuring-point will also change there. In this process, the spectral reflection properties of the optical waveguide are also changed. Consequently, the light reflected at varying measuring-points is intended to provide an indication of the temperature at the varying measuring-points of the optical waveguide, for example by evaluation of the spectral properties, in particular in conjunction with a registered propagation-time.

Document GB 2 207 236 A describes, moreover, an arrangement with an optical fiber, which has an optical interferometer which has measuring paths and reference paths. Through the use of continuous light in the measuring paths and reference paths, and of additional light pulses only through the measuring paths in the opposite direction to the continuous light, in order in this way to generate transient variations in the propagation constant of the light, inferences as to the temperature are to be made possible.

Document CN 102175344 A likewise describes the determination of the temperature by using an optical waveguide, wherein use is made of light of varying wavelengths. In this case a reference system is constructed, in order in this way to infer the temperature.

An optical measuring method is known, furthermore, from document CN 102881107. In this method, light pulses are fed into an optical waveguide, and Stokes and anti-Stokes signals are ascertained, in order in this way to infer the temperature by reference to a reference optical waveguide. Furthermore, a limiting temperature value is output that is adapted to the ambient temperature.

### SUMMARY OF THE INVENTION

Subject-matter of the present invention is a battery system, including at least one battery component which has at least one measuring-point, and including an optical waveguide which is connected to the measuring-point in thermally conducting manner, wherein a light-source, for radiating light of a defined frequency into the optical waveguide, and an optical detector, for detecting light emerging from the optical waveguide, are provided, wherein a thermochromatic material is provided which is connected to at least one measuring-point in thermally conducting manner and is positioned in a beam path of the optical waveguide.

The present battery system permits the detection of the overshooting of a maximum temperature or the undershooting of a minimum temperature of at least one battery component of the battery system in straightforward and cost-effective manner.

The battery system consequently includes at least one battery component. The battery component may be, in principle, any component or structural member that is part of a battery system known as such, the temperature of which is to be detected or monitored. For example, the battery component may be an electrical terminal, such as an electrode for instance, or a housing or similar. Correspondingly, the battery system may be, in particular, an electrochemical energy-storage system which is based, for instance, on a lithium-ion battery. In addition to the battery as such, open-loop and/or closed-loop control technology—such as a battery management system, for instance—may furthermore be encompassed by the battery system. Consequently the battery system may have, in addition to the components described below, at least one open-loop and/or closed-loop control unit.

The battery component has at least one measuring-point which serves to ascertain or to monitor the temperature of the battery component. The measuring-point may be, for example, an arbitrary point on a housing and/or may be arranged in such a manner that said point is connected in thermally highly conducting manner to a position that is subject to great fluctuations in temperature or that has a temperature which is to be monitored particularly reliably. In this regard the invention is not limited to one measuring-point; rather, within the scope of the present invention a plurality of measuring-points may equally well be present, even though the invention is described in the following mostly with reference to one measuring-point.

The battery system further includes an optical waveguide which is connected to the measuring-point or to a plurality of measuring-points in thermally conducting manner. An “optical waveguide” in this regard may be understood to mean, in particular, a component of such a type that has an input, through which light can be radiated or coupled into the optical waveguide, and that has an output from which light can emerge from the optical waveguide or can be coupled out. For example, the optical waveguide may be a longish, filiform element which is able to conduct light in its interior or core from one end, the input, to another end, the output, and, where appropriate, conversely, it also being possible for the light to be guided by curvatures of the optical waveguide.

Furthermore, a light-source, for radiating light of a defined frequency into the optical waveguide, and an optical detector, for detecting light emerging from the optical waveguide, are provided. Consequently the light-source is designed, in particular, to generate light of a defined frequency and is positioned together with the optical waveguide in such a manner that the generated light can be radiated or coupled into the optical waveguide, in particular into the input. Furthermore, the detector—such as a photodiode, for instance—is designed for this purpose and is positioned together with the optical waveguide in such a manner that light emerging from the optical waveguide, in particular from the output, radiates into the detector and can be detected by the latter.

In this regard, the light-source and/or the detector may expediently be connected to the open-loop and/or closed-loop control unit, in order in this way to be able to monitor the temperature in particularly preferred manner, as described below.

The invention provides, moreover, that a thermochromatic material is provided which is connected to the measuring-point in thermally conducting manner. A “thermochromatic material” in this regard is to be understood to mean, in particular, a material of such a type that, by reason of a change in temperature, changes its color, in particular reversibly. By virtue of a discoloration or by virtue of a change in color, the transmission of the light by this thermochromatic material is likewise changed. Furthermore, a “thermally conducting connection of the thermochromatic material to the measuring-point” is to be understood to mean that a change in temperature of the measuring-point has an effect on the thermochromatic material. In this regard, the strength or quality of the thermally conducting connection can, in principle, be chosen freely, to the extent that a temperature influence of the measuring-point on the thermochromatic material is application-dependent in such a manner that a change in color is sufficiently perceptible when a limiting temperature is exceeded or fallen short of

For example, a thermally conducting material may be arranged between the optical waveguide and the measuring-point, in order to enable a sufficient transfer of heat and to ensure that the thermochromatic material exhibits a temperature that does not exhibit an undesirably great interval from the actual temperature of the measuring-point.

Depending on the system requirements, it may be advantageous to heat or to cool the thermally conducting material. A possible application of the heating or cooling is the diagnosis of the sensor technology, since in this way an alteration of the color of the material can be obtained by force.

For example, the optical waveguide may be fixed to the measuring-point, for instance by means of a thermally highly conducting adhesive—such as a thermally highly conducting epoxy adhesive, for instance—or by welding, so that a preferred thermal coupling obtains.

The thermochromatic material in this case is positioned in a beam path of the optical waveguide. For example, the thermochromatic material may be a constituent part of the optical waveguide. In other words, the thermochromatic material is arranged in such a manner that it can be transradiated by light conducted through the optical waveguide. In particular, the thermochromatic material may be present in the optical waveguide, for example in the core, so that the light radiating through the optical waveguide is able to shine through the thermochromatic material.

By virtue of the configuration of the battery system described above, it is made possible for a temperature of a battery component or of a plurality of battery components to be monitored in straightforward, cost-effective and secure manner. In particular, it can be made possible for the overshooting or undershooting of a limiting temperature value to be detected securely. This is because, by virtue of the fact that an optical waveguide is provided, the light-source and the detector can be mounted at a fundamentally favorable position. No influence is exerted by optical waveguide on the positioning of the light-source and the detector. In addition, the optical waveguide can easily contact the most diverse measuring-points without exhibiting significant restrictions with respect to the positioning.

Consequently, the battery system described above enables, in particular, a wide-ranging check of various measuring-points with respect to temperature limits. This permits the secure and reliable initiation of countermeasures—such as, for instance, heating, cooling or shutting down certain components—if predetermined temperature parameters do not obtain.

Furthermore, by virtue of the provision of a thermochromatic material a discoloration of the thermochromatic material can be used straightforwardly as an indicator of a temperature overshoot or temperature undershoot. To the extent that, for example, appropriate comparative values are stored in an evaluating unit—such as, for instance, the battery management system—the ascertainment and evaluation of the transmission of the light can be drawn upon straightforwardly for the purpose of monitoring the temperature. In this respect, the intensity of the absorption or transmission of the light, for instance, as well as the color of the light shining through the thermochromatic material can be evaluated. For this purpose, comparatively simple and inexpensive light-sources and detectors are sufficient, in which case the computing power for an evaluation continues to be restricted. This is because, by virtue of the fact that only one detector suffices for a plurality of measuring-points, the evaluation and, furthermore, the data processing can be kept low. Furthermore, the radiating of light of a defined frequency may be capable of being realized by a plurality of simple arrangements.

Consequently, in the case of a battery system described above, a small number of inexpensive and robust structural members are sufficient to make available a secure monitoring of temperature. This reduces the cost and the effort in the course of manufacture of the battery system. Furthermore, by virtue of the few structural members and the selection of the usable structural members, it is possible to create a very stable and robust arrangement which can also be employed without difficulty in mobile applications.

In addition, the battery system described above enables good adaptability, since a monitoring of a desired temperature range can be made possible, for instance by a selection of the thermochromatic material. In this connection, merely the frequency of the light being used—such as, for instance, the color of the light being used—needs to be adapted to the characteristic of the thermochromatic material, this being possible, however, without difficulty for many light-sources, in particular with the aid of suitable filters.

An advantageous aspect of the use of a thermochromatic material is, furthermore, the fact that the alteration of the color is usually totally reversible, so that an exchange is not necessary, even after a change in color, in which connection, however, an irreversible alteration of the color in the sense of the present invention is also not excluded.

In this regard, the invention may provide that the light-source is supplied with energy by the battery system itself, so that no further source of current is needed. This can further reduce the costs of the method. In the sense of the present invention, however, it is not excluded that a further source of current is provided which, for instance, is independent of the battery system and is suitable to supply the light-source with current.

Consequently, through the selection of suitable thermochromatic materials a desired temperature range can be monitored straightforwardly, and, as a result, a countermeasure can be initiated in the event of a deviation of the temperature from a desired working temperature.

To sum up, a secure and robust possibility for monitoring the temperature of one or more battery components is made possible in straightforward and cost-effective manner.

Within the scope of one configuration, an LED may be provided as light-source. In particular, by using an LED (light-emitting diode) it is possible without difficulty to generate light having a precisely defined frequency and to couple it into the optical waveguide or to conduct it through the optical waveguide. In addition, an LED as light-source offers the advantage of high long-term stability, making it possible that service intervals do not need to be reduced as a result of the use of the LEDs, so that a reliable and stable application is possible. Finally, through the use of an LED it can be made possible for the method to be implemented particularly cost-effectively, since LEDs are distinguished, in particular, by a low current consumption. Consequently, the use of LEDs is possible without difficulty even when a plurality of light-sources are needed. In addition, by virtue of an LED it can also be made possible for light of varying frequencies to be emitted from only one light-source, so that detailed evaluating methods are also possible with little effort.

Within the scope of a further configuration, it may furthermore be possible that a reference optical waveguide is provided for the purpose of ascertaining changes in the transmission of the light guided through the optical waveguide. For this purpose, the reference optical waveguide, just like the optical waveguide, can be transradiated by light of defined frequency, in which case the light emerging from the reference optical waveguide is detectable. In this configuration, the battery system can operate particularly precisely, since, for example, deviations of the light being used, or of the detector, are detectable by virtue of the reference path, and in this way can be evaluated with the obtained result of the measuring optical waveguide. In this regard, the invention may provide that the reference optical waveguide is coupled with the measuring-point in a manner comparable to the measuring optical waveguide, or is at least partly thermally decoupled from the measuring-point. “Thermal decoupling” in this regard may be understood to mean, in particular, that an increase in temperature of the measuring-point has no effect—or at least no significant effect—on the reference optical waveguide. For this purpose, thermal insulations, for example, may be provided which protect the reference optical waveguide. The intensity of the thermal decoupling may, in turn, be chosen in a manner depending on the desired application. It may be advantageous, in particular, that an increase in the temperature of one or more measuring-points or of the respective battery components has no effect or only limited effect on the temperature of the reference optical waveguide.

The reference path or the reference optical waveguide should preferentially exhibit the same light-conducting properties as the measuring path; the thermochromatic or thermochromic material should therefore preferentially be present in comparable quantity.

The measurement can, for example, be equilibrated with the reference path. For example, the radiation intensity of a light-emitting diode (LED) is subject to production-induced fluctuations and ageing effects. The forward current of the diode influences the radiation intensity as well. This current, in turn, varies by reason of the tolerances of the electronic circuit.

The effects of such changes can be eliminated by reference measurements if the changes act equally on the reference path and the measurement path. The intensity threshold or the temperature determination is established relative to the reference measurement.

Furthermore, the invention may provide that the reference optical waveguide is transradiated by the same light-source as the measuring optical waveguide, or that at least one specific light-source is provided in each instance for the measuring optical waveguide and the reference optical waveguide. Corresponding remarks apply to the detector.

With the scope of a further configuration, the invention may provide that at least two different thermochromatic materials are provided which are connected to the at least one measuring-point in thermally conducting manner, in which case the two different thermochromatic materials are arranged in the beam path of one optical waveguide or in a respective beam path of different optical waveguides, and the different thermochromatic materials are consequently present in different optical waveguides. Correspondingly, the different thermochromatic materials may, in turn, be transradiated by light of defined frequency, in which case the light that emerges from the optical waveguide(s) is detectable. In this case, the different thermochromatic materials may, in particular, exhibit different thermochromatic effects—that is to say, in particular, they may exhibit an alteration of color at varying temperatures.

This configuration makes it possible for varying temperatures to be monitored in particularly advantageous manner. Consequently, both a maximum temperature and a minimum temperature can be monitored simultaneously, for instance. Furthermore, in this way it may be possible to monitor not only a sharp limiting value from which countermeasures would have to be initiated, for example. In particular in this configuration it is possible, furthermore, that in addition to the actual limiting value a temperature is monitored that exhibits a defined safety margin from the actual limiting value. As a result, a control system, for example, can intervene, or comparatively harmless countermeasures can be initiated, so that the battery can, where appropriate, continue to be operated straightforwardly.

In this configuration the invention may provide, for example, that the two or more thermochromatic materials are provided in a respective optical waveguide, so that, for example, a plurality of optical waveguides are provided with a respective thermochromatic material. In this regard, it is possible that identical or different light-sources may find application. Correspondingly, it is possible that identical or different detectors may find application.

Alternatively, in this configuration the invention may provide that the two or more different thermochromatic materials are arranged in a common optical waveguide and are arranged, for example, downstream relative to one another with respect to the direction of the light. In this configuration, with respect to the thermochromatic materials the number of light-sources and detectors can consequently be reduced.

Alternatively, in this configuration the invention may provide that the two or more optical waveguides are combined with respectively different thermochromatic materials in a bundle. In this configuration, in advantageous manner the light-source and the detector should be optically linked to all the optical waveguides. At the measuring-points, all the optical waveguides of the bundle must be thermally linked to the measuring-point.

It may furthermore be possible that at least one thermochromatic material is provided that above a temperature T1 exhibits a higher transmission of the light guided through the optical waveguide than below temperature T1, and that at least one thermochromatic material is provided that above a temperature T2 exhibits a lower transmission of the light guided through the optical waveguide than below temperature T2, where T2 is higher than T1, or that at least one thermochromatic material is provided that above a temperature T1 exhibits a lower transmission of the light guided through the optical waveguide than below temperature T1, and that at least one thermochromatic material is provided that above a temperature T2 exhibits a higher transmission of the light guided through the optical waveguide than below temperature T2, where T2 is higher than T1. Furthermore, the aforementioned may proceed at identical frequencies or with respect to the different thermochromatic materials at different frequencies, and the materials may, in turn, be present in one optical waveguide or in different optical waveguides.

In particular in this configuration, the adherence to a desired temperature window of the battery component can be monitored, since both above temperature T2 and below temperature T1 the transmission may be increased or reduced, so that an overshooting of a maximum temperature or an undershooting of a minimum temperature is detectable particularly easily.

In this connection the invention may, in principle, provide that two different thermochromatic materials are provided which are arranged, in particular, downstream relative to one another with respect to the direction of propagation of the light in the optical waveguide. With respect to the frequency of the light, in this case the invention may provide that the change in color of the different materials obtains at the same frequency or at different frequencies. In the former case, one light-source may then suffice; in the latter case, two light-sources may be an advantage.

It may furthermore be possible that suitable thermochromatic materials are ascertained by appropriate measurements or experiments, in order to adapt said materials to the desired field of application. The procedure adopted may be, for instance, in accordance with the following principle. Firstly, the transmission spectra of various thermochromic materials at varying temperatures or at varying wavelengths are ascertained. Then a material or a pairing of materials can be selected that satisfies the desired requirements.

For example, a pairing of “mirrored spectrum” materials may be selected. This means that, for instance, at a temperature T1<T2 or below T1 and at a wavelength λ1 or frequency f1 material A exhibits a high absorption and, as a result, a low transmission, whereas, at the same temperature, material B exhibits a low absorption and hence a high transmission. At a temperature T2>T1 and, where appropriate, above T2 and at a wavelength λ2 or frequency f2, on the other hand, the materials behave the other way round: material A has low absorption and material B has a high absorption.

An exemplary combination of thermochromatic materials comprises, for example, as material A, a hydrogel network comprising PVA-borax-cresol-red-3-(N,N-dimethyl-n-dodecylammonium)propanesulfonate, as is known, for instance, from Seeboth et al. “Thermochromic Polymers—Function by design”, Chem. Rev., 2014, 114 (5), 3037-3068, and, as material B, 10,12-pentacosadiynoic acid (PCDA) or a poly(PCDA)/ZnO nanocomposite, for instance in a matrix consisting of polyvinyl alcohol, as are known, for instance, from N. Traiphol, et al., Journal of Colloid and Interface Science, 356 (2011) 481-489.

These materials, for example, exhibit advantageous properties with respect to their thermochromic effects at varying wavelengths of the radiated light, as will be briefly explained below.

Material A described above exhibits a temperature-dependent absorption at a wavelength of 550 nm, whereas material B exhibits substantially a constant absorption at this wavelength. At a wavelength of 650 nm, on the other hand, material A exhibits substantially no absorption but exhibits a total transmission, whereas material B exhibits a temperature-dependent absorption.

Using materials of such a type, in this way, for example, a measurement with a light of a wavelength of 550 nm can firstly be carried out, whereby an absorption on the part of material A can be ascertained. Subsequently a measurement with a light of a wavelength of 650 nm can be carried out, whereby an absorption on the part of material B can be ascertained. The varying measurements may in this case be carried out successively and, for instance, at intervals of one second, though intervals of more than or less than one second are also possible. If now a measurement with a specific wavelength is directed toward a lower temperature limit, and a further measurement is directed toward an upper temperature limit, a defined temperature window can be monitored in this way.

Within the scope of a further configuration, it may furthermore be possible that the optical waveguide exhibits a material that is selected from the group consisting of glass, glass fiber and plastics. In particular, optical waveguides of such a type can make it possible for the light to be passed through in very loss-free manner, so that an alteration of the color of the thermochromatic material can be ascertained particularly effectively. In addition, the aforementioned materials are very stable and therefore highly suitable for use in battery systems.

With regard to further technical features and advantages of the battery system described above, reference is hereby made expressly to the following description of the method, to the figures and to the description of the figures, and conversely.

Subject-matter of the present invention is, furthermore, a method for monitoring a temperature of a battery component, having the following steps:
a) radiating light of a defined frequency into an optical waveguide, wherein said optical waveguide is connected to at least one measuring-point of the battery component in thermally conducting manner, wherein a thermochromatic material is provided which is connected to the measuring-point in thermally conducting manner and is positioned in a beam path of the optical waveguide;
b) detecting the light emerging from the optical waveguide;
c) determining a temperature range of the at least one measuring-point on the basis of the detected light.

To sum up, a method of such a type permits, in straightforward and cost-effective manner, a secure and robust monitoring of the temperature of one or more battery components.

To this end, the method includes, according to method step a), the radiating of light of a defined frequency into an optical waveguide. For example, light of one frequency or of several frequencies can be radiated, in order to transradiate the optical waveguide. For this purpose, use may be made of one LED or of a plurality of LEDs, for example.

By virtue of the fact that the optical waveguide is connected to at least one measuring-point of the battery component in thermally conducting manner, a thermochromatic material being provided which is connected to the measuring-point in thermally conducting manner and is positioned in a beam path of the optical waveguide, an alteration of the temperature of the battery component or, to be more exact, of the measuring-point can give rise to an alteration of the color of the thermochromatic material.

In this regard, the thermochromatic material can be chosen in such a manner that it exhibits a change in color that result a desired interval from a maximum or minimum operating temperature, in order, where appropriate, to be able to initiate countermeasures in good time.

According to method step b), the invention further provides that the light emerging from the optical waveguide is detected, and according to method step c) a temperature range of the battery component is determined on the basis of the detected light.

By virtue of the fact that light of a defined frequency is conducted through the thermochromatic material, in the course of the method described above it can consequently be ascertained, on the basis of the absorption or transmission of the light, whether a temperature range of the battery component is present that is located above or below a temperature at which the thermochromatic material changes its color. As a result, the operating temperature of one or more battery components can be monitored in straightforward and secure manner.

In this connection, the invention may provide that method step a) is carried out using light of at least two different frequencies, said different frequencies being used, in particular, in temporal succession. In this case a short time-interval of, for example, ≦10 s, for instance ≦5 s, for example ≦1 s, may be chosen for instance, in which case the temporal lower limit may be given by the configuration of the respective light-source, of the detector and also of the evaluation technology or control technology. By no means in restrictive manner, a temporal lower limit may amount to 0.5 s. In this configuration, it may be particularly preferred if different thermochromatic materials are present that exhibit, for instance, a change in color at varying frequencies, said changes in color obtaining, in particular, at varying temperatures. In this configuration, a particularly great variability of the measurement can be made possible, for instance with respect to the monitoring of varying temperature ranges or with respect to the monitoring of a minimum temperature and a maximum temperature. For example, a plurality of light-sources may be used for the radiating or coupling-in of light of varying frequencies.

Purely by way of example, in this configuration an optical waveguide may be used that exhibits two different thermochromatic materials downstream with respect to a direction of propagation of the light transradiating the optical waveguide, a first thermochromatic material being configured in such a manner that with respect to a light with frequency f1 it exhibits a higher transmission above a temperature T1 than below temperature T1, and a second thermochromatic material being configured in such a manner that with respect to a light with frequency f2 it exhibits a lower transmission above a temperature T2 than below temperature T2, where f1 and f2 are the same or, advantageously, different, and where T2 is higher than T1, and the optical waveguide being successively transradiated with light of frequencies f1 and f2.

Within the scope of a further configuration, the invention may provide that the method is carried out in periodically repeating manner, in which case a rate of repetition is preferentially chosen as a function of a relaxation-time of the thermochromatic material. In this configuration, a particularly secure and accurate monitoring of the temperature of the battery can be made possible. This is because, on the one hand, the temperature can be monitored substantially at any time, as a result of which an operation outside a desired temperature range can be substantially excluded. In addition, by virtue of the fact that the relaxation-time of the thermochromatic material is taken into consideration, a reliable alteration of the color of the thermochromatic material can be ascertained at all times, as a result of which the monitoring of the temperature is also particularly reliable. “Relaxation” in this regard is to be understood to mean, in particular, the process of attaining a state in which the change in color is totally concluded. Correspondingly, the “relaxation-time” is to be understood to mean, in particular, the period of time that the relaxation requires. In other words, the relaxation period is the period of time that persists up until a totally concluded change in color and that starts, in particular, at the beginning of the change in color.

With regard to further technical features and advantages of the method described above, reference is hereby made expressly to the description of the battery system, to the figures and to the description of the figures, and conversely.

### BRIEF DESCRIPTION OF THE DRAWINGS

Further advantages and advantageous configurations of the subject-matters according to the invention will be illustrated by the drawings and elucidated in the following description, wherein the described features—individually or in an arbitrary combination—may be a subject-matter of the present invention unless the contrary results unequivocally from the context. In this regard, it is to be noted that the drawings have only descriptive character and are not intended to restrict the invention in any way. Shown are:

FIG. 1 a schematic representation of a configuration of a battery system;

FIG. 2 a schematic representation of a further configuration of a battery system;

FIG. 3 a diagram showing the frequency of light-sources that is being used;

FIG. 4 a diagram showing the transmission of light of two frequencies through an optical waveguide having two exemplary thermochromatic materials;

FIG. 5a)-5c) a schematic diagram showing advantageous frequency properties of thermochromatic materials.

### DETAILED DESCRIPTION

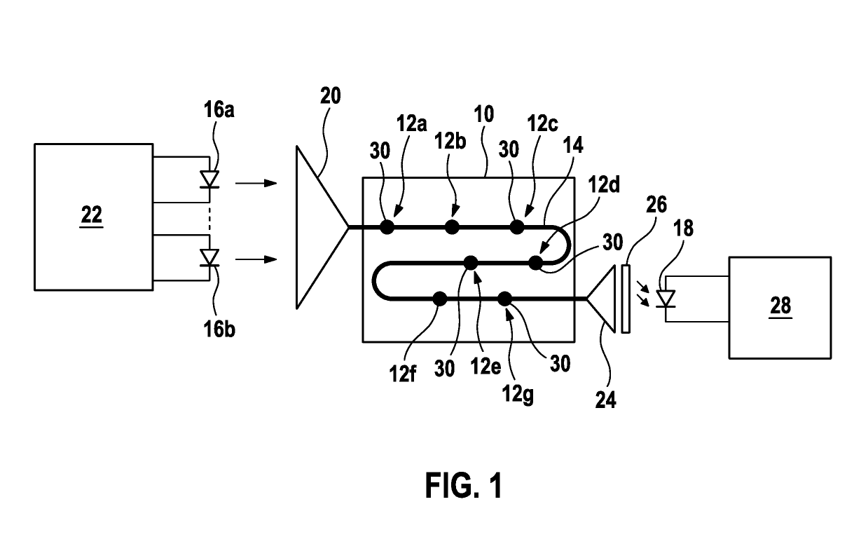

A schematic representation of a configuration of a battery system according to the invention is shown in FIG. 1.

The battery system includes at least one battery component 10 which has at least one measuring-point 12 which may be, for instance, part of a battery cell. In the configuration according to FIG. 1, a total of seven measuring-points 12_{a-g} are shown. The battery system 10 further includes an optical waveguide 14, for example of tubular structure or with a circular or oval cross-section, which is connected to the measuring-points 12_{a-g} in thermally conducting manner. For example, the optical waveguide 14 is bonded to the measuring-points 12_{a-g} of the battery component 10 with a thermally conducting adhesive, or it is welded to the measuring-points 12_{a-g}.

Furthermore, a light-source 16—according to FIG. 1, two light-sources 16ₐ, 16_{b}—is provided for the purpose of radiating light of a defined frequency into the optical waveguide 14, and an optical detector 18 is provided for the purpose of detecting light emerging from the optical waveguide 14. The light-sources 16ₐ, 16_{b}, each constituted by an LED for example, can radiate light of different frequencies, and the detector 18 may be, for example, a photodiode. Moreover, an optical link 20, such as a lens for instance, may be provided between the light-sources 16ₐ, 16_{b} and the optical waveguide 14, in order to be able to couple the light suitably into the optical waveguide 14. Furthermore, an electrical circuit 22 is provided which is able to drive the light-sources 16ₐ, 16_{b}. For example, the circuit 22 may be part of an open-loop and/or closed-loop control unit such as the battery management system, for instance.

For example, the circuit 22 together with the light-sources 16ₐ, 16_{b} may be arranged on or alongside one or more battery cells or a corresponding housing. Furthermore, the optical waveguide 14 may pass through a module and thereby run along the various measuring-points 12_{a-g}.

At the end of the optical waveguide 14 a further optical link 24 is provided which connects the output of the optical waveguide 14 to the detector 18, in order to detect, in the detector 18, the light emerging from the optical waveguide 14. Optionally, an optical filter 26 may be provided which is transradiated by the light emerging from the optical waveguide 14 and which is arranged, for instance, on the optical link 24, for example in the optical link 24 or between the optical link and the detector 18. By virtue of the optical filter 26, the light can be filtered with respect to the frequency, which can simplify the detection. The detector 18 may be connected to an electrical circuit 28 which serves to evaluate the data ascertained by the detector 18. For example, the circuit 28 may be part of an open-loop and/or closed-loop control unit—such as the battery management system, for instance—and/or may evaluate the measuring current of a photodiode.

The invention provides, moreover, that the optical waveguide 14 exhibits a thermochromatic material 30 which is connected to the measuring-points 12_{a-g} in thermally conducting manner and is positioned in a beam path of the optical waveguide 14. In particular, the thermochromatic material 30 may be arranged in the entire optical waveguide 14 or only at defined positions, for instance adjacent to the measuring-points 12_{a-g}. In this case, the thermochromatic material 30 is drawn schematically and may be located, for instance, only within the optical waveguide 14.

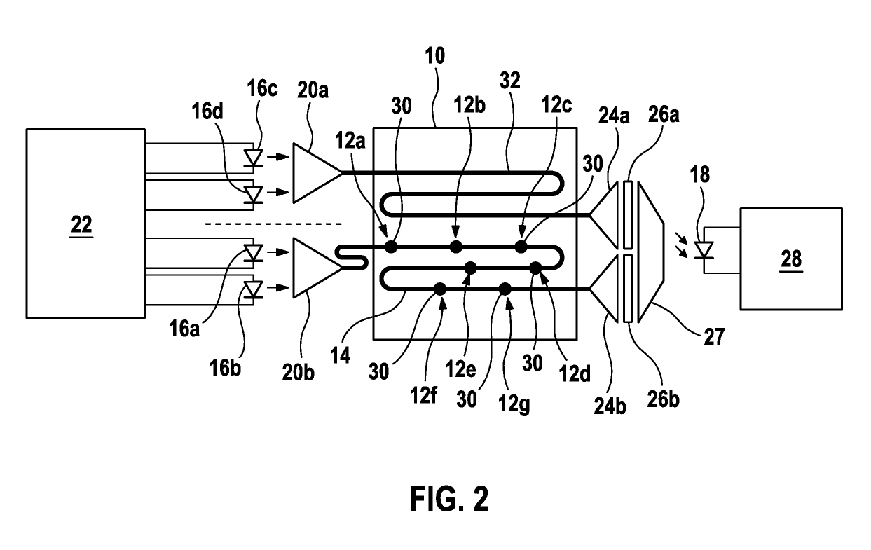

A further configuration of a battery system is shown in FIG. 2, wherein with respect to FIG. 1 the same or comparable structural members are provided with the same reference symbols.

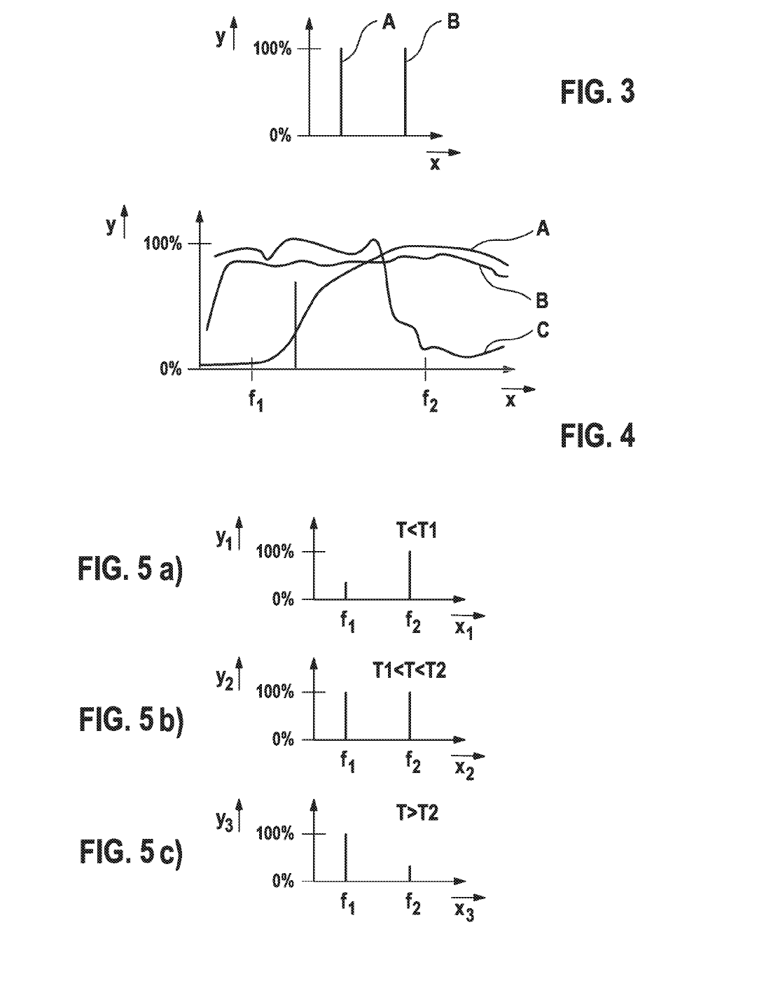

In FIG. 2 it is shown, in particular, that a reference optical waveguide 32 is provided which is able to guide light emitted from two light-sources 16_{c}, 16_{d} which likewise may be configured as LEDs. Light-sources 16_{c}, 16_{d} can likewise emit light of a defined frequency which may be identical to the frequency of light-sources 16ₐ, 16_{b}. For example, light-sources 16ₐ, 16_{c} can emit light having a frequency f1, and light-sources 16_{b}, 16_{d} can emit light having a frequency f2. This is shown in FIG. 3, for example, in which the frequency of the light is plotted on the X-axis against the intensity of the light on the Y-axis. In this case, line A shows the frequency of light-sources 16ₐ, 16_{c}, and line B shows the frequency of light-sources 16_{b}, 16_{d}.

Furthermore, the optical waveguide 14 and the reference optical waveguide 32 may be connected by a common optical link 24 or by a respective optical link 24a, 24b such as one or two prisms, for instance. From the optical link(s), the light can, in turn, pass through one or two optical filters 26a, 26b and can be conducted from there into the detector 18 through a further optical link 27—likewise configured as a prism, for example—in which case two optical filters 26a, 26b may, moreover, are provided.

For example, two different thermochromatic materials 30 may be arranged downstream relative to one another with respect to a direction of propagation of the light transradiating the optical waveguide 14, a first thermochromatic material 30 being configured in such a manner that with respect to a light having a frequency f1 it exhibits a higher transmission above a temperature T1 than below temperature T1, and a second thermochromatic material 30 being configured in such a manner that with respect to a light having a frequency f2 it exhibits a lower transmission above a temperature T2 than below temperature T2, f1 and f2 being different, and T2 and T1 being different. In particular, T2 is higher than T1, and the first thermochromatic material 30 exhibits a high transmission at frequency f2 within the entire temperature range presented, and the second thermochromatic material 30 exhibits a high transmission at frequency f1 within the entire temperature range presented.

In FIG. 4 a diagram is shown which shows the effect of the aforementioned thermochromatic materials 30. In this diagram, the frequency of a light radiated into the optical waveguide 14 is plotted on the X-axis, and the transmission of the light that shines through the two different thermochromatic materials 30 is plotted on the Y-axis. In this diagram, curve A relates to a temperature below T1, curve B relates to a temperature between T1 and T2, and curve C relates to a temperature above T2. By virtue of the specifications of the thermochromatic materials 30, there is a high transmission between T1 and T2 with respect to both frequencies being used. Furthermore, the transmission drops both above temperature T2 and below temperature T1. As a result, whenever the temperature is outside the desired temperature range this can always be detected by a declining transmission of at least one of the frequencies f1 and f2.

An exemplary measuring method using a photodiode as detector 18 may then proceed, for example, as follows. Firstly, light-source 16ₐ, which radiates with frequency f1, is activated, and the relaxation-time of the thermochromatic material is waited out, and subsequently the measuring current in the photodiode is ascertained. Subsequently, light-source 16ₐ is deactivated and light-source 16_{b} is activated, and the measuring current of the photodiode is ascertained after the relaxation-time. Subsequently light-source 16_{b} is deactivated, and the relaxation-time is waited out. On the basis of a comparison of the ascertained measuring currents with predetermined limiting values, it can be output whether a minimum temperature T1 is being fallen short of or whether a maximum temperature T2 is being exceeded. A measuring cycle of such a type can be repeated periodically, in which case the period between two repetitions may be dependent on the relaxation-time of the thermochromatic material 30.

An evaluation based on the configuration described above is shown by way of example in FIG. 5 and may then proceed as follows. In detail, in FIG. 5 three diagrams arranged one above the other are shown, in which the frequency is plotted in each instance on the X-axis, and the transmission of the light guided through the optical waveguide 14 is shown on the Y-axis. In this case, diagram a) shows a state in which the temperature of the measuring-point 12 is less than T1 (T<T1), diagram b) shows a state in which the temperature of the measuring-point 12 lies between T1 and T2 (T1<T<T2), and diagram c) shows a state in which the temperature of the measuring-point 12 lies above T2, where T2 is higher than T1 (T>T2).

Corresponding to the aforementioned specifications, a high transmission obtains at frequency f1 in states T1<T<T2 and T>T2, and a low transmission obtains in state T<T1, whereas at frequency f2 a high transmission obtains in states T<T1 and T1<T<T2, and a low transmission obtains in state T>T2.

With respect to the detector 18, and here, by way of example, to the measuring current of a photodiode, this means that, in a state of T<T1, light-source 16ₐ, which radiates with frequency f1, brings about a low measuring current, and light-source 16_{b}, which radiates with frequency f2, brings about a high measuring current. In a state of T1<T<T2, both light-sources 16ₐ and 16_{b} bring about a high measuring current and, in a state of T>T2, light-source 16ₐ, which radiates at frequency f1, brings about a high measuring current, and light-source 16_{b}, which radiates at frequency f2, brings about a low measuring current.

1. A battery system comprising:
at least one battery component (10) which has at least one measuring-point (12_{a-g}),
at least one optical waveguide (14) connected to the measuring-point (12_{a-g}) in a thermally conducting manner,
a light-source (16_{a-d}) for radiating light of a defined frequency into the optical waveguide (14), and
an optical detector (18) for detecting light emerging from the east one optical waveguide (14), and
a thermochromatic material (30) connected to the at least one measuring-point (12_{a-g}) in a thermally conducting manner and positioned in a beam path of the optical waveguide (14).

2. The battery system as claimed in claim 1, the light-source (16_{a-d}) comprises an LED.

3. The battery system as claimed in claim 1, further comprising a reference optical waveguide (32) for ascertaining changes in the transmission of the light guided through the at least one optical waveguide (14).

4. The battery system as claimed in claim 1, further comprising at least two different thermochromatic materials (30) which are connected to at the least one measuring-point (12_{a-g}) in a thermally conducting manner, wherein the two different thermochromatic materials (30) are arranged in the beam path of the at least one optical waveguide (14) or, in a respective beam path of different optical waveguides (14).

5. The battery system as claimed in claim 4, wherein at least one thermochromatic material (30) is provided that above a temperature T1 exhibits a higher transmission of the light guided through the at least one optical waveguide (14) than below temperature T1, and in that at least one thermochromatic material (30) is provided that above a temperature T2 exhibits a lower transmission of the light guided through the at least one optical waveguide (14) than below temperature T2, where T2 is higher than T1, or in that at least one thermochromatic material (30) is provided that above a temperature T1 exhibits a lower transmission of the light guided through the at least one optical waveguide (14) than below temperature T1, and in that at least one thermochromatic material (30) is provided that above a temperature T2 exhibits a higher transmission of the light guided through the at least one optical waveguide (14) than below temperature T2, where T2 is higher than T1.

6. The battery system as claimed in claim 1, wherein the at least one optical waveguide (14) is made from a material that is selected from the group consisting of glass and plastics.

7. A method for monitoring a temperature of a battery component (10), having the following method steps:
a) radiating light of a defined frequency into an optical waveguide (14), wherein said optical waveguide (14) is connected to at least one measuring-point (12_{a-g}) of the battery component (10) in thermally conducting manner, wherein a thermochromatic material (30) is provided which is connected to at least one measuring-point (12_{a-g}) in a thermally conducting manner and is positioned in a beam path of the optical waveguide (14);
b) detecting light emerging from the optical waveguide (14);
c) determining a temperature range of the at least one measuring-point (12_{a-g}) on the basis of the detected light.

8. The method as claimed in claim 7, wherein method step a) is carried out using light of at least two different frequencies.

9. The method as claimed in claim 7, wherein the method is carried out in periodically repeating manner.

10. The method as claimed in claim 9, wherein a rate of repetition is chosen as a function of a relaxation-time of the thermochromatic material (30).
